(19) United States
(12) Patent Application Publication
(10) Pub. No.: US 2016/0275584 A1
(43) Pub. Date: Sep. 22, 2016

(54) SYSTEM, METHOD, AND APPARATUS FOR PERSONALIZING GREETING CARDS

(71) Applicants: Janell Gibson, San Pedro, CA (US); David Gibson, San Pedro, CA (US)

(72) Inventors: Janell Gibson, San Pedro, CA (US); David Gibson, San Pedro, CA (US)

(21) Appl. No.: 14/659,890

(22) Filed: Mar. 17, 2015

(51) Int. Cl. G06Q 30/06

(52) U.S. Cl. CPC G06Q 30/0621

(57) ABSTRACT

A method, system, and apparatus are provided for personalizing electronically printed greeting cards so that any generally applicable messages printed therein particularly address any intended recipients. In an embodiment, the system may prompt a user to upload a remote address book containing mailing information and one or more personal details relating to each of her intended recipients. For example, the one or more personal details may comprise any gifts given by the card recipient to the card sender. The one or more details may be automatically incorporated into a generally applicable message template and then sent to the corresponding recipient according to the mailing information thus avoiding the need to draft individual messages.

### CROSS-REFERENCE TO RELATED APPLICATIONS

Pursuant to 35 USC 119, this application claims the right of priority to Provisional Patent Application Ser. No. 62/065,205 filed on Oct. 17, 2014. The content of said application is incorporated herein by reference in its entirety.

### GOVERNMENT CONTRACT

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to greeting cards and, more particularly, to a system, method, and apparatus for fully customizing electronically printed greeting cards for a plurality of recipients, while still providing personalized information directed at each intended recipient.

### BACKGROUND

It is customary to send greeting cards to family, friends, acquaintances, and even business clients and associates for different occasions. Often, holiday greetings, event invitations, and thank you cards, for example, are sent from one sender to many individual recipients at once. Although cards sent in bulk may contain common information, it is often desirable to customize the cards by including a personal message directed to a specific recipient along with unique photos and/or other graphic designs arranged on the card.

Some have offered cards that are customizable in terms of size, shape, and overall design. For example, U.S. Pat. No. 7,236,258 to Wen et al. discloses a method of sending batched orders of greeting cards that include personal photos. In another example, U.S. Pat. No. 8,351,190 to Sneed et al. discloses a self-contained vending machine that prints individual greeting cards featuring customized visual and audio designs selected by a customer on-site. Still, all of the solutions heretofore suggested have been insufficient to solve the problem of efficiently providing fully customized electronically printed greeting cards that contain messages that address individual recipients. In particular, existing systems and methods require that personalized images and messages be generally applied to all of the cards across an entire order. As a result, even messages that have been custom-drafted by the sender are written in generic terms so that they may broadly apply to all of the recipients who are meant to receive them.

Customizing a plurality of electronically printed greeting cards so that they relate specifically to any individual recipient can be time consuming, labor intensive, and costly. For example, when a person chooses to send a plurality of electronically printed greeting cards, he or she must usually handwrite any message that is meant to particularly address an individual recipient. Thus, when sending a thank you card to guests of a party, the sender must handwrite a note thanking the recipient for any specific gift given by the recipient regardless of whether a generally applicable, preprinted note was already included in the card. For those planning to send as many as tens, or even hundreds, of greeting cards, the amount of time it would take to handwrite individualized messages to each recipient can be prohibitive, leaving the customer to simply send generic and impersonal greetings. Many senders might even be physically incapable of the laborious task of handwriting individual notes due to conditions such as carpal tunnel syndrome. Handwritten notes may even interfere with the neat and professional look achieved by electronically printing greeting cards in the first place. In other instances, a customer may choose to electronically draft individual messages to be printed on each card that he sends. Although this avoids physical discomfort and injury, it is still time-intensive and inefficient and may still be time prohibitive when sending many greeting cards at once.

Although various proposals have been made to solve the problem of impersonal greeting cards, none of those in existence combine the characteristics of the present invention. Therefore, there is a need for a method, system, and apparatus for efficiently providing electronically printed greeting cards that allow customers to include messages unique to each of their intended recipients.

### SUMMARY

The present disclosure is directed to a method, system, and apparatus that provides customers with electronically printed greeting cards that may be fully customizable in terms of design and moreover fully personalized to address each card recipient. More particularly, the invention, in part, automatically incorporates personalized recipient information into a message template that comprises a generally applicable message body and one or more variables. The variables, in particular, may be edited to specifically address an individual recipient. According to the various embodiments, the invention allows customers to create greeting cards that include seemingly personal messages or notes to each recipient while avoiding the need to manually draft such notes themselves.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the invention is a greeting card customization system which comprises an electronic device operative to: provide a greeting card template; provide a message template; receive mailing information attributable any parties, or recipients, that a customer may wish to send a greeting card to; receive additional variables such as personalized recipient information that corresponds to each recipient; and automatically incorporate such variables into the message template to form a message unique to each recipient. The system and electronic device are further adaptable to execute the method for personalizing electronically printed greeting cards.

The message template may comprise, in part, a note that is generally applicable to all of the recipients who a customer wants to send a greeting card to. For example, if a customer is sending thank you cards for gifts given by guests at her wedding, a message template may be provided which includes a generally applicable note that thanks all of the guests for attending the wedding. Alternatively, if a customer is sending invitations to an event, a message template may be provided which includes a generally applicable note that includes a time, date, location, and purpose for the event. Although only two are listed, many different scenarios are contemplated for sending such cards. For example, a customer may choose to send cards to announce a birth, graduation, or other achievement, to indicate a change of address, before and/or after a ceremony, for a birthday party, holiday greeting, or even death in the family. Of course, this should not be read to limit the invention to the particular scenarios listed, but merely to illustrate the applicability of the invention. Indeed, it is contemplated that the system, method, and apparatus may be directed to any scenario in which a customer wishes to send electronically printed cards with personal notes directed at each card recipient while avoiding the hassle of individually drafting such notes.

In a preferred embodiment, the message template may further comprise one or more variables that correspond to each of the customer's recipients. For example, the variables may include personalized recipient information. In one embodiment, the personalized recipient information may be any recipient names or nicknames that the customer uses to individually identify each of her recipients. In another embodiment, the personalized recipient information may include one or more details that are particularly attributable to a recipient. For example, when a customer is sending thank you cards for gifts given by guests at her wedding, the one or more details might comprise the specific gift given by a particular recipient. In another embodiment, the one or more details might include the role that the individual played in the wedding ceremony or reception. In yet another embodiment, the one or more details might speak to the personal relationship between the customer and recipients.

In one embodiment, the system may prompt a customer to manually input any desired variables. In another embodiment, the system may access a remote address book or other tabulation including a listing of the desired variables. For example, many people use Microsoft Excel® to store contact names and addresses in the form of a spreadsheet. In an embodiment, a user may put additional rows and columns in her existing spreadsheet indicating various personalized recipient information. The system may automatically incorporate any indicated personalized recipient information into the message template when it accesses her spreadsheet to populate the address region. Then, having received such personalized recipient information according to any of the embodiments, the system may automatically incorporate it in the body of the message template.

Other personalizable variables may be opening and closing salutations as well as the customer's signature. It is contemplated, for example, that each of the variables may be altered by the customer depending on such factors as his or her relationship or familiarity with a particular recipient. In one embodiment, such as in addressing a business associate, it may be appropriate to include a formal closing salutation. Common examples of exemplary formal closing salutations may be “Sincerely,” “Respectfully,” or “Kind regards.” In another embodiment, it may be appropriate to include a more casual or familiar closing salutation. Common examples of exemplary familiar closing salutations may be “Love always,” “Hugs and kisses,” or “Yours truly.”

Of course, such salutations and other personalizable variables are offered simply by way of example and not of limitation. It is contemplated that a customer may instruct the system to automatically incorporate more or less variables in the message template as he or she chooses.

In a preferred embodiment, the system may personalize greeting cards completely. For example, in one embodiment, the greeting card template may be defined by greeting card size, shape, configuration, color, and material. Each of these defining characteristics may be particularly indicated by a customer designing his or her greeting card. The system may even be instructed to include other personal elements on the card. In a preferred embodiment, a customer may instruct the system to include personal photos on the greeting card. She may even indicate the placement of such photos on the card herself. In another embodiment, other design features such as flourishes, borders, and other graphic designs may also be included on the greeting card.

The system may further provide a means for storing any design choices indicated by a customer. Moreover, it may provide a means for storing any remote or manual address books as well as variables and personal recipient information associated with each address and individual therein.

In a preferred embodiment, the system may receive an order to print greeting cards that include the various designs instructed by the customer. Moreover, the system may receive an order to print greeting cards that include a unique message or note to each recipient.

In another embodiment, the invention is a method for creating custom, personalized electronically printed greeting cards comprising the steps of: accessing a greeting card customization program adaptable for execution on an electronic device; providing a greeting card template; receiving mailing information attributable to a plurality of intended recipients; receiving additional personalized recipient information corresponding to each of the plurality of intended recipients; and automatically incorporating the personalized recipient information into the message template to form a plurality of unique messages.

In still another embodiment, the invention is a non-transitory, tangible computer-readable medium having stored thereon computer-executable instructions, which when executed by a computer processor, enable performance of a method comprising: receiving instructions to create a greeting card template defined by a selected size, shape, color, configuration, and material; providing a message template; receiving mailing information attributable to a plurality of intended recipients; receiving additional personalized recipient information corresponding to each of the plurality of intended recipients; and automatically incorporating the personalized recipient information into the message template to form a plurality of unique messages, each unique message corresponding to one of the intended recipients.

These and other objects, features, and advantages of the present invention will become apparent in the following detailed description of the present embodiment thereof when read in conjunction with the accompanying drawings wherein the same reference numerals denote like or similar parts throughout several views.

Although the description that follows contains many specificities, these should not be construed as limiting the scope of the embodiments but as merely providing illustrations of some of several embodiments. Thus the scope of the embodiments should be determined by the claims that are appended and their legal equivalents, rather than by the examples given. Those skilled in the art to which this invention pertains will be able to devise other forms thereof within the ambit of the appended claims.

### BRIEF DESCRIPTION OF THE DRAWINGS

FIG. 1 is a flowchart showing an exemplary embodiment of a method for personalizing greeting cards;

FIG. 2 is a diagram of a communication network in which an exemplary embodiment of a system for personalizing greeting cards is implemented;

FIG. 3 is an exemplary embodiment of the electronic device from FIG. 2;

FIGS. 4A-C show exemplary embodiments of a user interface for the system and method for personalizing greeting cards; and

FIGS. 5A-C show exemplary embodiments of personalized electronically printed greeting cards.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

The terms “next,” “then,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

A method, system, and, apparatus are provided for personalizing greeting cards. In particular, the method, system, and apparatus allow customers to create messages or notes specific to each recipient of the greeting card while avoiding the need to individually draft each message or note by matching personal recipient information to the corresponding recipient's address.

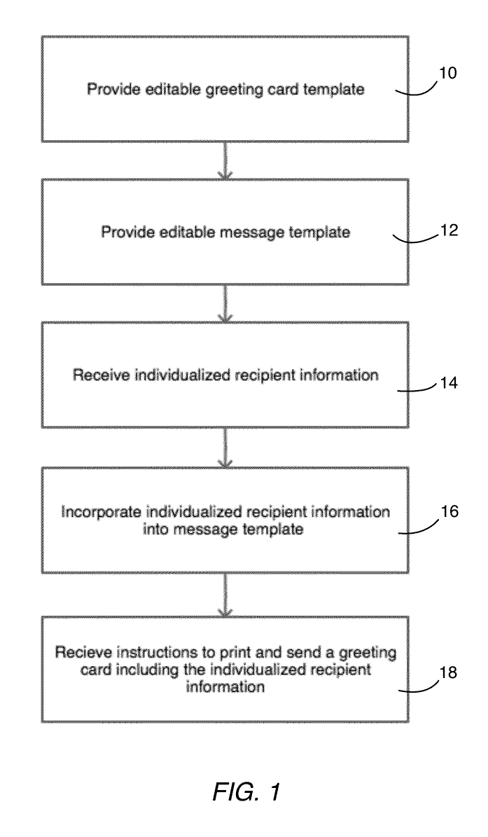

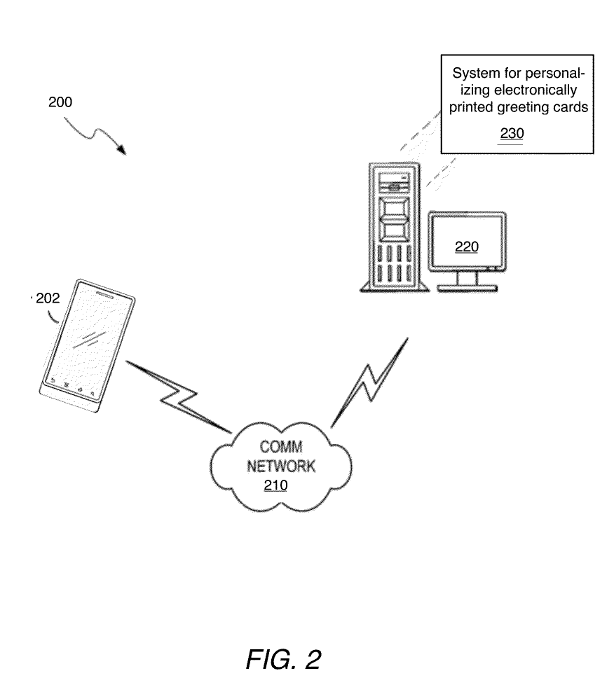

With reference to FIG. 1, an exemplary method for personalizing electronically printed greeting cards is illustrated. In particular, a customer may access a greeting card customization program via an electronic device 100. The electronic device will be discussed in further detail with reference to FIG. 2 below. Having accessed the greeting card customization program 100, mailing information may be received 102 from a customer. Many people use Microsoft Excel® to store contact names and addresses in the form of a spreadsheet. In one embodiment, the receiving mailing information step 102 may be effected by uploading one such spreadsheet, or other remote address book, to the greeting card customization program. In another embodiment, the greeting card customization program may prompt a customer to manually input or type each title and address associated with each of the recipients that he or she wishes to send a greeting card to. In yet another embodiment, the mailing information corresponds to each of the recipients that a customer wishes to send a greeting card to. In even another embodiment, the mailing information may include a customer's entire contact list. In that case, a user may select or deselect any contacts that he or she wishes to exclude from a particular greeting card mailing. Independent of the source of the mailing information, such information received from a customer may later be paired with variables and/or personalized recipient information so that any unique message or note created with such information is appropriately sent to the recipient corresponding to such details.

A greeting card template may also be provided 104. In a preferred embodiment, the greeting card template may be defined by greeting card size, shape, configuration, color, and material. Each of these defining characteristics may be particularly chosen by a customer designing his or her greeting card. In this manner, it is contemplated that a customer may be able to use the method, system, and apparatus to completely design and personalize any greeting cards he or she is seeking to order.

In one embodiment, a customer may instruct the greeting card customization program to provide a greeting card template embodying particular dimensions, including length and height. For example, a greeting card may be sized four inches by five inches, five inches by seven inches, or any other dimensional measure indicated by a customer. Available shapes may include traditional square or rectangle typical of greeting cards. The shape of the greeting card may be further directed at having rounded or pointed edges. However, it is also contemplated that a customer may choose other non-traditional shapes, such as a heart, oval, circle, triangle, or any other shape, for her card.

A customer may further instruct the greeting card customization program to create a greeting card with a particular folded configuration depending on the content she wishes to include. For example, she may choose a postcard configuration. Since a postcard has only two sides and no folds, the configuration may be appropriate for simple greetings with little or simple content. Alternatively, a traditional folded card, or cards with various panels achieved by a triple fold or more may be desirable where a customer has more content they wish to share with their recipients. Colors, of course, should not be limited and may be available from any color code system, such as HTML color code. A customer may instruct the greeting card customization program to apply any color choices to the greeting card itself, and/or to various other elements of the card. For example, in one embodiment, she may instruct the greeting card customization program to provide a greeting card presenting a single color choice for the letters of the written message. The message or note color choice may be different than the color selected for the card itself. In another embodiment, the customer may instruct the system to make the written message or note or even additional design elements, such as borders and flourishes, more than one color.

Of course, the customer may even instruct the greeting card customization program to provide a greeting card having a particular material. For example, the greeting card customization program may be instructed to provide a greeting card that will ultimately be electronically printed on materials such as cardstock or photo paper, where the material may further have a matte, glossy, or satin finish, and may even be chosen based on weight or thickness. None of the above, however, is offered to limit the invention, and is instead provided to offer examples of possible greeting card templates ultimately provided to a customer 104.

Any of the above selections associated with providing a greeting card template 104 may be made in view of the purpose of sending the greeting card. Thus a customer may choose to instruct the greeting card customization program to provide greeting cards having a different size, color, configuration, or material depending on the type of occasion the card is for. However, it should be understood that the greeting card system, method, and apparatus are applicable for any possible type of greeting card including, for example, birthday cards, invitations, thank you notes, birth and death announcements, engagements, change of address notices, business mailings, wedding invitations. Of course, this list should not be read as limiting the method, system, and apparatus to the particular scenarios listed, but merely to illustrates the applicability of the invention. Indeed, it is contemplated that the system, method, and apparatus may be directed to any scenario in which a customer wishes to send electronically printed cards with personal notes directed at each card recipient while avoiding the hassle of individually drafting such notes.

Next, a message template is provided 106. The message template may be particularly applicable to the type of occasion addressed by the greeting card and may comprise, in part, a note that is generally applicable to all of the recipients who a customer wants to send a greeting card to. For example, if a customer is sending thank you cards for gifts given by guests to her wedding, a message template may be provided which includes a generally applicable note that thanks all of the guests for attending the wedding. Alternatively, if a customer is sending invitations to an event, a message template may be provided which includes a generally applicable note that includes a time, date, location, and purpose for the event. Of course, other purposes for sending cards, as well as generally applicable information, is contemplated. The listed scenarios are simply provided to clarify, rather than limit the invention.

In a preferred embodiment, the message template further comprises one or more variables that correspond to each of the customer's recipients. In particular the variables, which might not be generally applicable to each of the recipients included with the customer's mailing information, may include personalized recipient information, which the program is adapted to receive from a customer 108. In one embodiment, the personalized recipient information may be any recipient names or nicknames that the customer uses to individually identify each of her recipients. In another embodiment, the personalized recipient information may include one or more details that are particularly attributable to a recipient. For example, when a customer is sending thank you cards for gifts given by guests at her wedding, the one or more details might comprise the specific gift given by a particular recipient. In another embodiment, the one or more details might include the role that the individual played in the wedding ceremony or reception. In yet another embodiment, the one or more details might speak to the personal relationship between the customer and each recipient.

In one embodiment, the receiving additional personalized recipient information step 108 may be achieved by prompting a customer to manually input any desired variables. In another embodiment, a customer may add variables to any spreadsheet comprising his or her remote address book so that they are automatically included when the greeting card customization program receives the customer's mailing information 102. Again, many people use Microsoft Excel® or other tabulation software to store contact names and addresses in the form of a spreadsheet. In an embodiment, a user may put additional rows and columns in her existing spreadsheet indicating various personalized recipient information. The system may then automatically incorporate any indicated personalized recipient information into the message template when it accesses her spreadsheet to populate the address region. Then, having received such personalized recipient information according to any of the embodiments, the system may automatically incorporate it in the body of the message template 110.

Other personalizable variables may be opening and closing salutations as well as the customer's signature. It is contemplated, for example, that each of the variables may be altered by the customer depending on such factors as his or her relationship or familiarity with a particular recipient. In one embodiment, such as in addressing a business associate, it may be appropriate to include a formal closing salutation. Common examples of exemplary formal closing salutations may be “Sincerely,” “Respectfully,” or “Kind regards.” In another embodiment, it may be appropriate to include a more casual or familiar closing salutation. Common examples of exemplary familiar closing salutations may be “Love always,” “Hugs and kisses,” or “Yours truly.”

Of course, such salutations and other personalizable variables are offered simply by way of example and not of limitation. It is contemplated that a customer may instruct the system to automatically incorporate more or less variables in the message template as he or she chooses.

In one embodiment, the system may prompt a customer to manually input any desired variables. In another embodiment, the system may access a remote address book or other tabulation including a listing of the desired variables. For example, many people use Microsoft Excel® to store contact names and addresses in the form of a spreadsheet. In an embodiment, a user may put additional rows and columns in her existing spreadsheet indicating various personalized recipient information. The system may automatically incorporate any indicated personalized recipient information into the message template when it accesses her spreadsheet to populate the address region. Then, having received such personalized recipient information according to any of the embodiments, the system may automatically incorporate it in the body of the message template 110. In this manner, a thoughtful and genuine note may be provided so that it specifically addresses each recipient of a greeting card.

The aforementioned functions can be performed by various components in various embodiments. For example, the functionality can be highly distributed across a network or less so by use of functions performed on local devices such as 202 in FIG. 2.

FIG. 2 shows an environment in which an exemplary embodiment of the system for personalizing electronic greeting cards. By way of example, and not limitation, system 200 comprises an electronic device 202, which is shown to be communicatively coupled to system 220 via a communication network 210. The electronic device may be embodied as a personal computing device such as, for example only and without limitation, a desktop, laptop or tablet computer that incorporates communicative functionality. Notably, the communications network can use one or more of various communications types such as, for example and without limitation, cellular and Wi-Fi communications.

Users of the electronic device 202 may use their devices to access the electronically printed greeting card program and further provide all of the instructions needed to create their card. In this exemplary embodiment, designing the greeting card is facilitated by a website that is hosted by server 220. As such, server 220 facilitates interaction between a customer and any facility capable of ordering, printing, and/or sending greeting cards. For the purpose of the example presented in FIG. 2, the potential customers includes the users of electronic device 202.

Additionally, server 220 implements the system for coordinating visits and facilitates sharing information related to visits with the network center amongst members of the social network. Specifically, the server 220 implements the method outlined in FIG. 1. Accordingly, a user or customer can access the server 220 using their electronic devices 202 and can instruct the system 230 to create a plurality of greeting cards, include personal messages in each, and further print and send the card according to any mailing information that has been included.

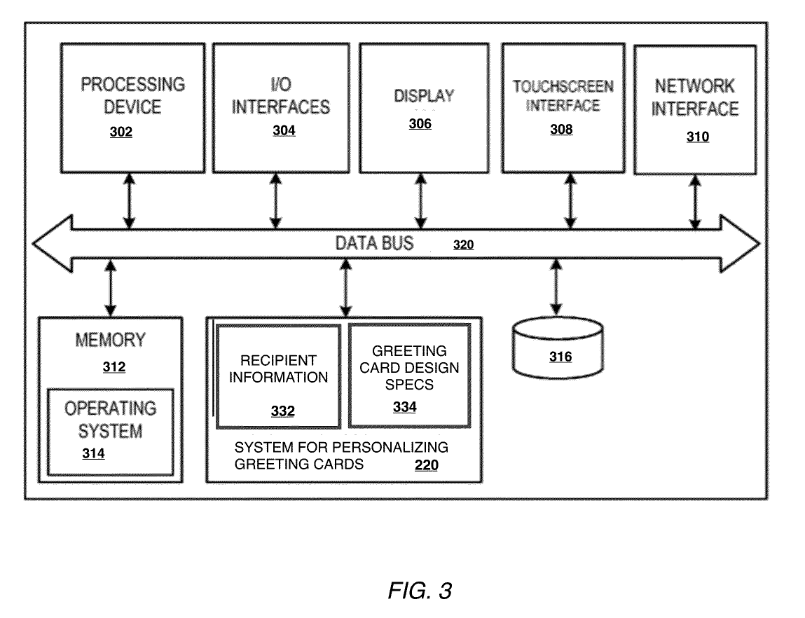

FIG. 3 illustrates mobile device 202 shown in FIG. 2. As described earlier, mobile device 202 may be a personal computer such as a desktop computer or mobile electronic device such as a laptop, tablet computer or smartphone. However, the electronic device may also be embodied in any one of a wide variety of wired and/or wireless computing devices. As shown in FIG. 2, electronic device 202 includes a processing device (processor) 302, input/output interfaces 304, a display 306, a network interface 310, a memory 312, an operating system 314, and a mass storage 316, with each communicating across a local data bus 320. In an embodiment where the electronic device is a smartphone tablet computer, or other electronic device having a touch sensitive display, the electronic device may also include a touchscreen interface 308. Additionally, electronic device 202 incorporates a system for personalizing electronically printed greeting cards 230, which is depicted as including recipient information 332, and greeting card template 334, although the location of information 332 and 334 could vary.

The processing device 302 may include any custom made or commercially available processor, a central processing unit (CPU) or an auxiliary processor among several processors associated with the electronic device 202, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the mobile device 202. In accordance with such embodiments, the components are stored in memory and executed by the processing device. Note that although depicted separately in FIG. 3, the system and method for providing personalized electronically printed greeting cards 200 may be resident in memory such as memory 312.

One of ordinary skill in the art will appreciate that the memory 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a communication network such as depicted in FIG. 2. When such components are embodied as an application, the one or more components may be stored on a non-transitory computer-readable medium and executed by the processing device.

In order to facilitate the aforementioned functionality, various aspects may be performed by one or more of the electronic devices 202. In one embodiment, mobile device is operative to perform, at least in part, the method depicted in the flowchart of FIG. 1. Specifically, this method includes: accessing a greeting card customization program (block 100); receive mailing information (block 102); providing a greeting card template (block 104); provide a message template (block 106); receive additional personalized recipient information (block 108); and incorporate personalized recipient information into the message template (block 110).

With respect to operation of system for personalizing electronically printed greeting cards 230, system 230 is operative to perform, at least in part, the method depicted in the flowchart of FIG. 1 as well.

If embodied in software, it should be noted that each block depicted in the accompanying flowchart represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the electronic device 202. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

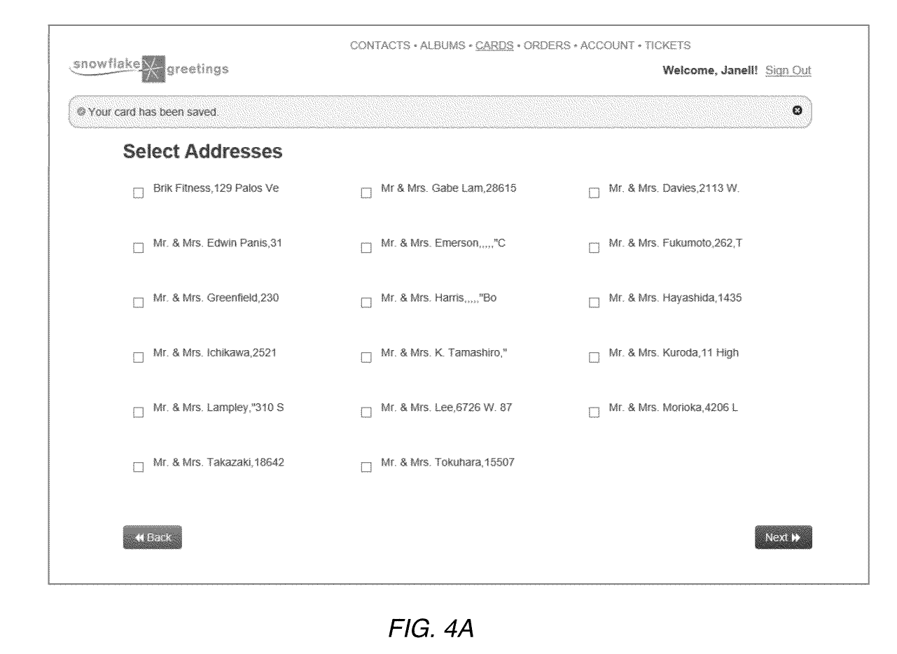

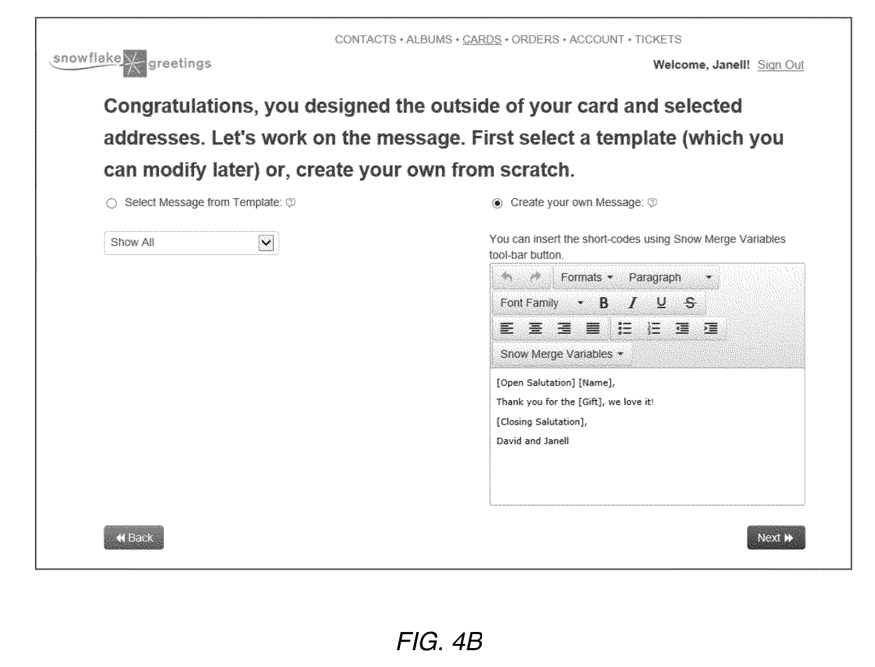

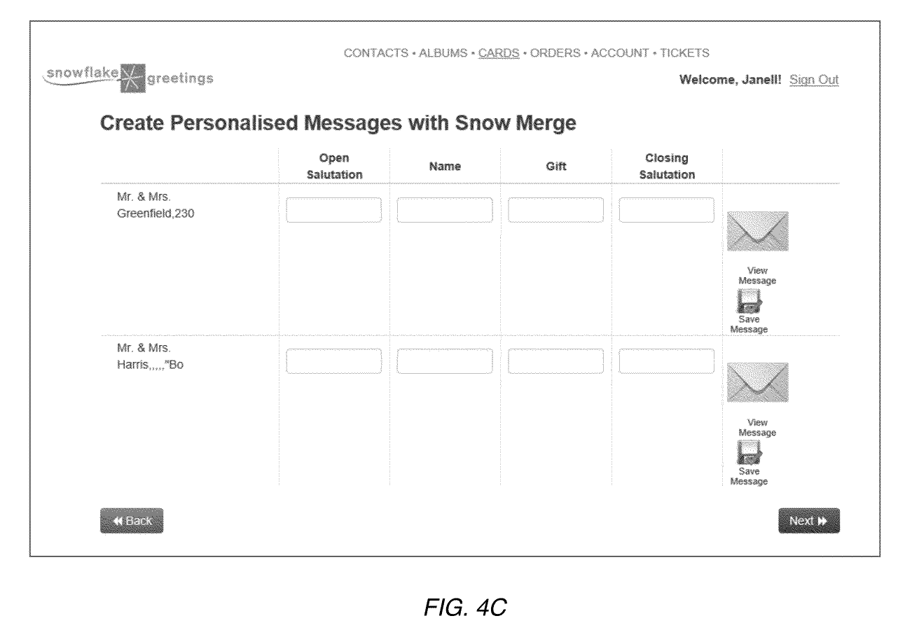

FIGS. 4A-C illustrate exemplary interfaces associated with the methods and systems for providing personalized electronically printed greeting cards, which are discussed above. According to one embodiment, a screen may show various portions of the method which may be navigable using typical “Back” and “Forward” buttons 402. In particular, FIG. 4A shows mailing information 404 associated with a customer's greeting card recipients. Although a finite list of titles and addresses have been particularly pointed out by reference numeral 404, it should be understood that a customer may include as many or as few recipients as he or she sees fit to send his or her greeting cards to. Thus, for example, boxes appear next to the titles and addresses in the mailing information 404 so that a user may select or deselect any of the recipients in the list, thereby choosing to send a personalized greeting card to each member of the recipient list or not. Such mailing information 404 may be saved for later or repeated access. In one embodiment, a customer may save the information by providing a user name and using it to identify him or herself 406 on the greeting card customization program.

FIG. 4B illustrates another embodiment of a user interface, and more particularly illustrates a message template 408. Personalized recipient information, such as name and gift, and other variables, such as open salutation and closing salutation, are show in brackets while the generally applicable note or message is shown without brackets. As shown, the words and characters “Thank you for the . . . , we love it! . . . David and Janell” are the generally applicable portion of the message template that can be generally applied to every card sent according to the chosen templates. With reference to FIG. 4C, the personalized recipient information and other variables may be assigned to the mailing information 404. In one embodiment, for example, a customer may be prompted to manually type an open salutation, name, gift, and closing salutation 410 to relate particularly to a recipient indicated by the mailing information 404. As discussed above, such personal recipient information and other variables may also be included in a remote address book or other tabulation so that it is automatically assigned to the mailing information 404.

In one embodiment, the message template 408 is editable at the discretion of the customer. In another embodiment, a message that incorporates the personalized recipient information and other variables 410 may be viewed 412 to ensure that the message or note is grammatically correct and otherwise suitable to send according to the mailing information 404. Again, the message template may be saved for later or repeated access.

In an embodiment, an additional interface may be provided for the customer to instruct the greeting card customization program to place an order to printing, and/or sending greeting cards according to the mailing information and personalized message templates.

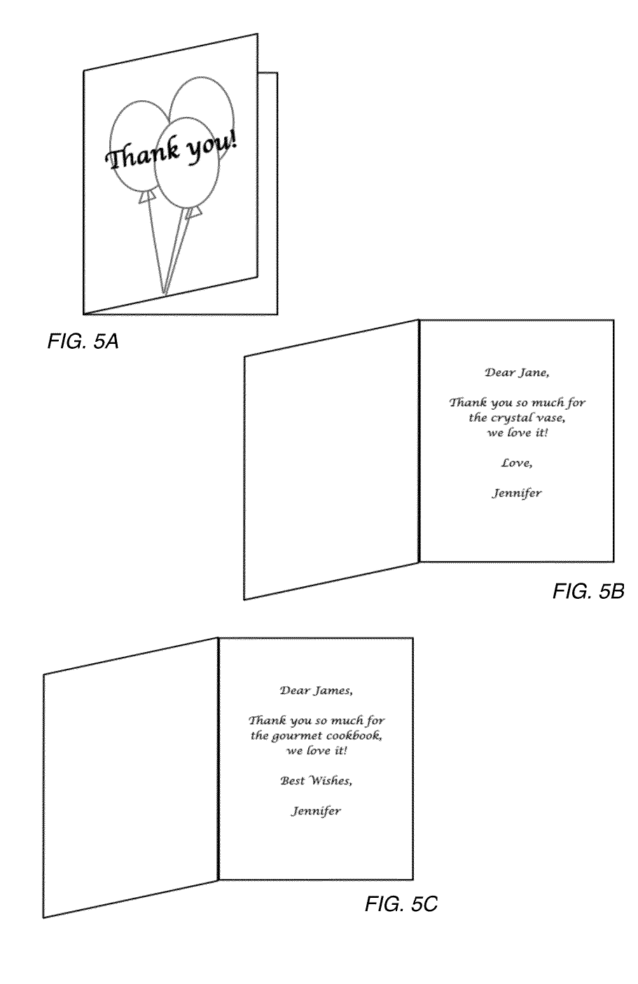

With reference now to FIGS. 5A-C, embodiments of the personalized greeting cards are provided. In an embodiment, the greeting card may be a rectangular card that is folded in half to include a front side 500 and inside 502. The greeting card may include a graphic image 504 intended generally for all of a customer's recipients. Here, generic, celebratory balloons and “Thank you!” label are shown, however, it is contemplated that a customer may instruct the greeting card customization program to include personal photos instead. Moreover, although a single graphic image 504 is shown on the front side 500 of the exemplary greeting card, it is contemplated that a customer may instruct the customization program to include a plurality of images on any side or surface and in any arrangement on the electronically printed greeting card.

FIGS. 5B and 5C show the inside 502 of two different greeting cards which include a message template featuring variables and personalized recipient information 508 that is specific to the recipient meant to receive each card. Here, the variables and personalized recipient information are underlined to particularly point them out in the message, however, it is contemplated that any variables and personalized recipient information may be printed to coordinate seamlessly with the remaining, generally applicable portion of the message template. It may be seen, for example, that the cards in both FIGS. 5B and 5C include a message thanking the recipient. However, FIG. 5B addresses a recipient “Jane,” thanking her for a “crystal vase,” and expresses “Love” as a closing salutation. FIG. 5C addresses a recipient “James,” thanking him for a “gourmet cookbook,” and expresses “Best wishes” as a closing salutation. Thus, sincere and personalized messages or notes are achieved while avoiding the hassle of individually drafting the message in each card. Although both include similar sentiments of thanks and gratefulness, both recipients will receive a greeting card that includes a message or note that is unique to them personally. As discussed above, however, such compositions are provided merely by way of example and not of limitation. Each of these variables may be altered or designated by the customer as he or she sees fit.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the style and content of each greeting card may be edited according to the needs and desires of a customer. Moreover, the nature and number of variables and other personalized recipient information may be changed as desired by the customer. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the method, system, and apparatus for creating personalized greeting cards with which that terminology is associated. In general, the terms used in the following claims should not be constructed to limit the method, system, and apparatus to the specific embodiments disclosed in the specification unless the above description section explicitly define such terms. Accordingly, the actual scope encompasses not only the disclosed embodiments, but also all equivalent ways of practicing or implementing the disclosed method, system, and apparatus. The above description of embodiments of the method, system, and apparatus for creating personalized greeting cards is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method and system are contemplated in any number of claim forms. Thus, the inventor reserves the right to add additional claims after filing the application to pursue such additional claim forms for other aspects of the method, system, and apparatus for creating personalized greeting cards.

What is claimed is:

1. A method for personalizing electronically printed greeting cards, comprising:
accessing a greeting card customization program adaptable for execution on an electronic device;
receiving mailing information attributable to a plurality of intended recipients;
providing a greeting card template;
providing a message template;
receiving additional personalized recipient information corresponding to each of the plurality of intended recipients; and
automatically incorporating the personalized recipient information into the message template to form a plurality of unique messages, each unique message corresponding to one of the intended recipients.

2. The method of claim 1, wherein the personalized recipient information incorporated into the message template comprises:
an opening salutation;
a name of a recipient; and
at least one detail attributable to each of the intended recipients;
a closing salutation;
wherein each of the opening salutation, name of the recipient, at least one detail attributable to each of the intended recipients, and closing salutation are editable to particularly address one of the plurality of intended recipients.

3. The method of claim 2, wherein the at least one detail attributable to each of the intended recipients is a chosen from either or both of a gift given by each intended recipient and the relationship of each intended recipient to a party sending the greeting card.

4. The method of claim 2, wherein the message template further comprises a message body that is generally applicable to all of the one or more intended recipients.

5. The method of claim 1, further comprising sending instructions to print and send greeting cards having a unique message according to the corresponding mailing information.

6. The method of claim 5, wherein the greeting card template is defined by greeting card size, shape, color, configuration, and material chosen by the customer.

7. The method of claim 1, further comprising storing the greeting card template, mailing information attributable to a plurality of intended recipients, and personalized recipient information corresponding to each of the plurality of intended recipients.

8. The method of claim 1, further comprising receiving personal photos to apply to the greeting card template.

9. A system for providing personalized electronically printed greeting cards, comprising:
an electronic device operative to:
access and store a remote address book comprising mailing information corresponding to one or more intended greeting card recipients;
receive and store additional personalized recipient information;
automatically incorporate additional personalized recipient information into a standard message body in order to compose a message unique to each recipient; and
place an order to print and send at least one greeting card including the message unique to each recipient.

10. The system of claim 9, wherein the electronic device is further operative to:
prompt a user to design a greeting card template and place an order to print and send a greeting card according to the designed greeting card template.

11. The system of claim 10, wherein the greeting card template is defined by greeting card size, shape, color, configuration, and material.

12. The system of claim 10, wherein the electronic device is further operative to store any designed greeting card template.

13. The system of claim 9, wherein the electronic device is further operative to prompt a user to manually input mailing information for one or more intended greeting card recipients.

14. The system of claim 13, wherein the electronic device is further operative to store manually inputted mailing information.

14. A non-transitory, tangible computer-readable medium having stored thereon computer-executable instructions, which when executed by a computer processor, enable performance of a method comprising:
receiving instructions to create a greeting card template defined by a selected size, shape, color, configuration, and material;
providing a message template;
receiving mailing information attributable to a plurality of intended recipients;
receiving additional personalized recipient information corresponding to each of the plurality of intended recipients;
storing the greeting card template, mailing information, and personalized recipient information; and
automatically incorporating the personalized recipient information into the message template to form a plurality of unique messages, each unique message corresponding to one of the intended recipients.
